(19) United States
(12) Patent Application Publication
(10) Pub. No.: US 2026/0102942 A1
(43) Pub. Date: Apr. 16, 2026

(54) PRINTABLE CONCRETE STRUCTURE MOLD FOR CONCRETE STRUCTURES

(71) Applicant: 1Print LLC, Wilmington, DE (US)

(72) Inventors: Adam C. Friedman, Buffalo, NY (US); Fredrik Wannius, Wellington, FL (US)

(21) Appl. No.: 19/360,628

(22) Filed: Oct. 16, 2025

Related U.S. Application Data
(60) Provisional application No. 63/707,820, filed on Oct. 16, 2024.

(51) Int. Cl. B28B 7/34; B28B 7/00; B28B 7/32; B33Y 80/00

(52) U.S. Cl. CPC B28B 7/346; B28B 7/0064; B28B 7/32; B33Y 80/00

(57) ABSTRACT

A concrete structure mold system and method for producing concrete structures that has a printed outer plate portion designed to circumscribe a first volume, the first volume designed to receive poured concrete therein. Included is at least one removable structure creating a second volume, the second volume designed to occupy a portion of the first volume and designed to have poured concrete form therearound. The printed outer plate portion may be created in sections that are assembled to create the completed concrete structure mold.

### CROSS-REFERENCE TO RELATED APPLICATIONS

This application claims priority pursuant to 35 U.S.C. 119(e) to U.S. Application No. 63/707,820, filed Oct. 16, 2024, which application is incorporated herein by reference in its entirety

### FIELD

The present disclosure generally relates to a printable concrete structure mold system and method for producing concrete structures.

### BACKGROUND

Generally, three-dimensional (“3D”) printing is a process that extrudes material layer by layer, forming an article of manufacture from the completed extrusion layers, also known as additive manufacturing. This process is used to manufacture smaller items, such as prototypes to full scale structures. The extrusion of material from the 3D printer must have a stable surface in order for the bead to accurately and precisely match a particular model. The model refers to a digital model, such a CAD model, which a 3D printer will use to guide the extrusion layers to create the particular configuration of each required layer, eventually “printing” the entire component or components.

Many known articles of manufacture are created via precast techniques, with concrete or stone. Precast articles are construction products produced by casting concrete in a reusable concrete structure mold, or “form”, which is then cured in a controlled environment, transported to the construction site and maneuvered into place; examples include precast beams, and wall panels for tilt up construction. Alternatively, cast-in-place concrete is poured into site-specific forms and cured on site.

For illustration, wave mitigation structures can come in a variety of forms such as breakwaters, seawalls, coastal dikes, buffer blocks, and recurved seawalls. Generally, these are physical structures that are positioned in locations, allowing the particular structure to physically brace against oncoming waves. These structures can be placed underwater, at sea level, or a combination thereof. It is common for these structures to be constructed via precast techniques.

Precast manufacturing techniques, however, can introduce a variety of issues with the finished articles, including, but not limited to: failure in sealing joints (e.g., joints can separate from one another which can compromise and weaken the structure); potential shipping issues (e.g., weight, size, and damage-avoidance precautions); offloading and rigging concerns (e.g., the need for large commercial-scale cranes); lack of flexibility (e.g., precast articles are built to drawing specifications that may not meet the dimensions of the installation, therefore making the article useless); and, repairing spalls, or cracks (e.g., spalls can occur from poor form construction, rough removal from forms, improper storage, early removal of the structure, and poor handling methods of the structure). Typically, wave-force mitigation structures are constructed via precast manufacturing techniques and can experience any of the aforementioned issues.

Wave mitigation structures and concrete structures in general are often made from concrete poured into concrete structure molds. Poured concrete structure molds are often made from steel. Creating steel concrete structure molds for poured concrete structures involves meticulous design, precise material selection, and skilled fabrication. Initially, engineers and architects develop detailed blueprints and 3D CAD models to visualize and refine the concrete structure mold design. Structural analysis ensures the concrete structure mold can withstand the pressure and weight of poured concrete. The appropriate steel grade is selected based on strength, durability, and resistance to wear and corrosion, with additional coatings and treatments applied to enhance longevity.

The fabrication process includes cutting steel plates and sections, forming them into desired shapes, and employing precision machining for exact tolerances. Welding assembles the formed pieces into a concrete structure mold structure, which is then finished by grinding, polishing, and applying surface treatments. Rigorous quality control ensures dimensional accuracy, surface finish, and structural integrity. Despite the thorough process, making last-minute design changes is challenging, as it often requires significant rework or the creation of entirely new concrete structure molds, resulting in delays and increased costs.

Operational drawbacks of steel concrete structure molds include high initial costs, significant weight, and complexity in fabrication, necessitating advanced machinery and skilled labor. Generally, these steel concrete structure molds also require a considerable amount of time to manufacture. Maintenance requirements and susceptibility to wear, thermal expansion, and corrosion further add to operational costs. The rigidity of steel concrete structure molds limits flexibility, making it difficult and costly to accommodate last-minute design changes from customers.

As a consequence, there is an unmet need on the market for an improved concrete structure mold and process for making concrete structure molds the is both flexible for design changes, cost-effective, time-efficient and precise.

### SUMMARY

Disclosed is a concrete structure mold that has a printed outer plate portion designed to circumscribe a first volume, the first volume designed to receive poured concrete therein. Included is at least one removable structure creating a second volume, the second volume designed to occupy a portion of the first volume and designed to have poured concrete form therearound.

In some embodiments of the concrete structure mold, the concrete structure mold is made from printed concrete. In some embodiments of the concrete structure mold, the concrete forming the concrete structure mold is reinforced and designed to withstand at least 12,000 pounds per square inch.

In some embodiments of the concrete structure mold, the outer plate portion comprises a first plate section designed to be coupled to at least one second plate section directly or by intervening at least one second plate sections. In some embodiments of the concrete structure mold, an inner wall portion of the outer plate portion is at least partially coated with a polymer-based substance. In some embodiments of the concrete structure an inner wall portion of the outer plate portion is at least partially coated with a silicone-based substance. In some embodiments of the concrete structure mold, the silicone-based substance further forms a non-planar concrete structure mold pattern. In some embodiments of the concrete structure mold, the silicone-base non-planar concrete structure mold pattern is designed to produce a textured surface such as coral-like nooks and crannies.

In some embodiments of the concrete structure mold, the at least one removable structure is an inflatable. In some embodiments of the concrete structure mold, the at least one removable structure is at least partly filled with water. In some embodiments of the concrete structure mold, the at least one removable structure is at least partly filled with a weighting substance. In some embodiments of the concrete structure mold, the at least one removable structure is tapered toward a base portion of the outer plate portion.

In some embodiments of the concrete structure mold, the outer plate portion is printed with at least one aperture designed to accommodate a portion of at least one of the at least one removable structures. In some embodiments of the concrete structure mold, the outer plate portion is printed with a contoured base portion of the outer plate portion. In some embodiments of the concrete structure mold, at least one metal loop portion is disposed on an outer side of the outer plate portion.

Disclosed further is a concrete structure mold producing method including the step of printing the outer plate portion designed to circumscribe the first volume, the first volume designed to receive poured concrete, adding substantially within the outer plate portion at least one removable structure, creating the second volume, the second volume designed to occupy the portion of the first volume, pouring concrete into the first volume. The method includes the step of allowing the poured concrete to become hardened, removing the outer plate portion from the hardened poured concrete, and collapsing and removing the removable structure.

The concrete structure mold producing method may further include the step of at least partly filling the removable structure with water. The concrete structure mold producing method may further include the step of at least partly filling the removable structure with the weighted substance.

The concrete structure mold producing method may further include the step of printing at least one aperture designed to accommodate the portion of at least one of the at least one removable structure. The concrete structure mold producing method may further include the step of printing the base portion of the outer plate portion with the contoured form.

These and other objects, features, and advantages of the present invention will become readily apparent upon the review of the following detailed description of the invention, in view of the drawings and appended claims.

### BRIEF DESCRIPTION

Various embodiments are disclosed, by way of example only, with reference to the accompanying schematic drawings in which corresponding reference symbols indicate corresponding parts, in which:

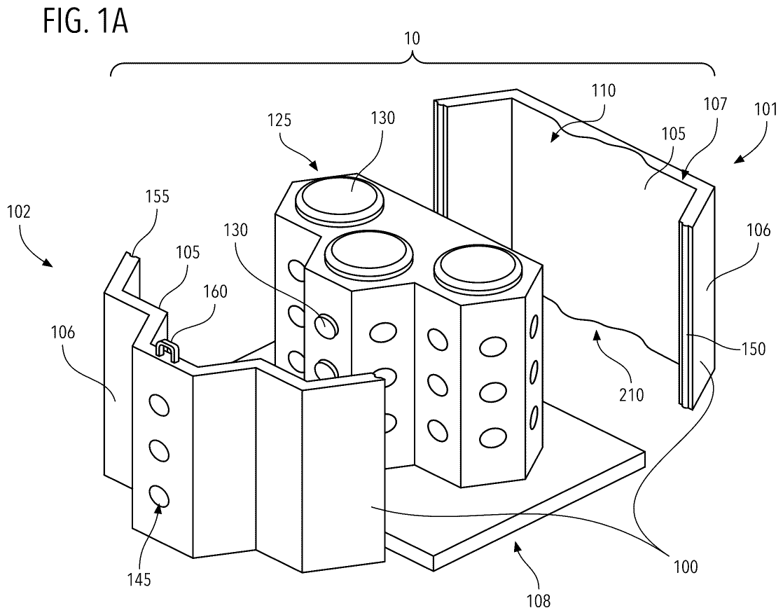

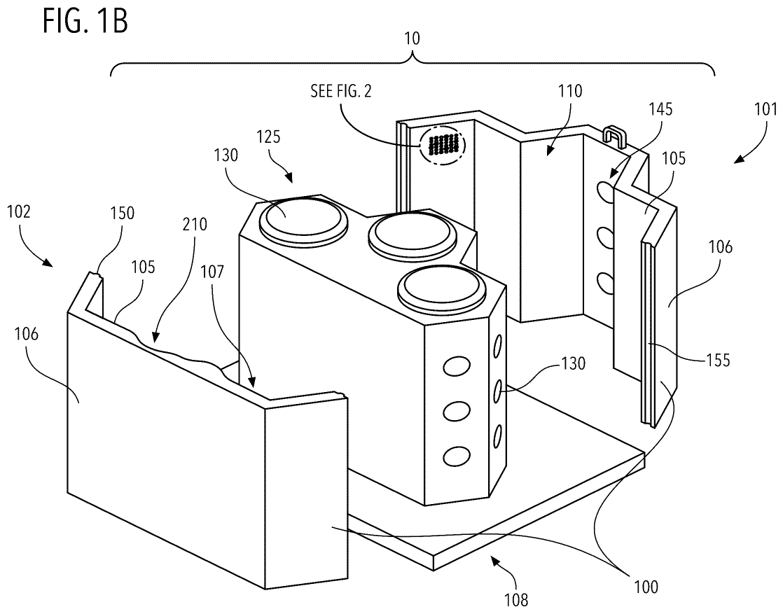

FIGS. 1A and 1B generally show perspective views of a concrete structure mold;

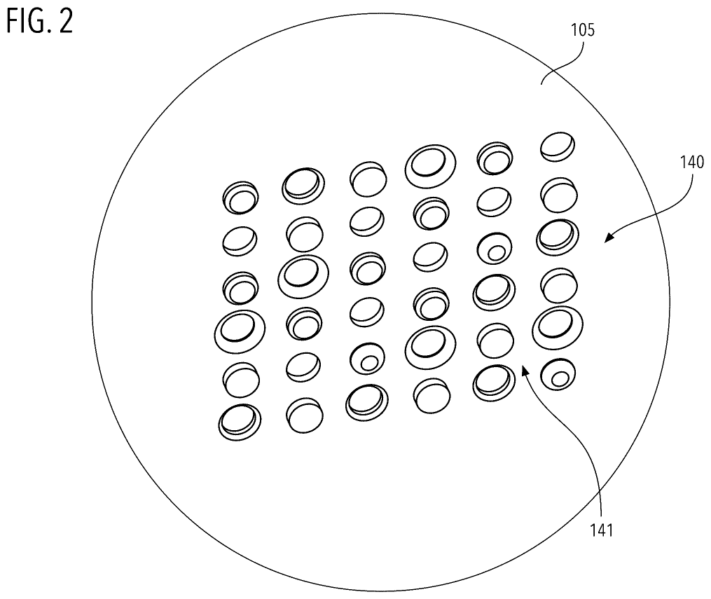

FIG. 2 is an enlarged view taken from FIG. 1B;

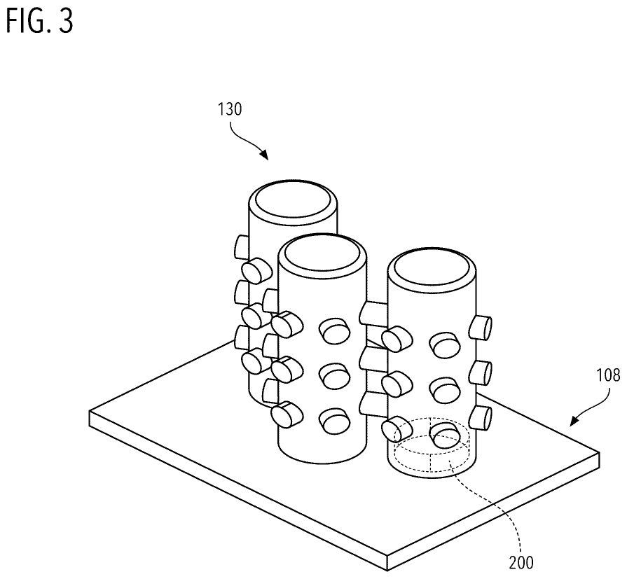

FIG. 3 illustrates an internal view of a collapsable structure with a weighted structure therein and placed on a foundation plate;

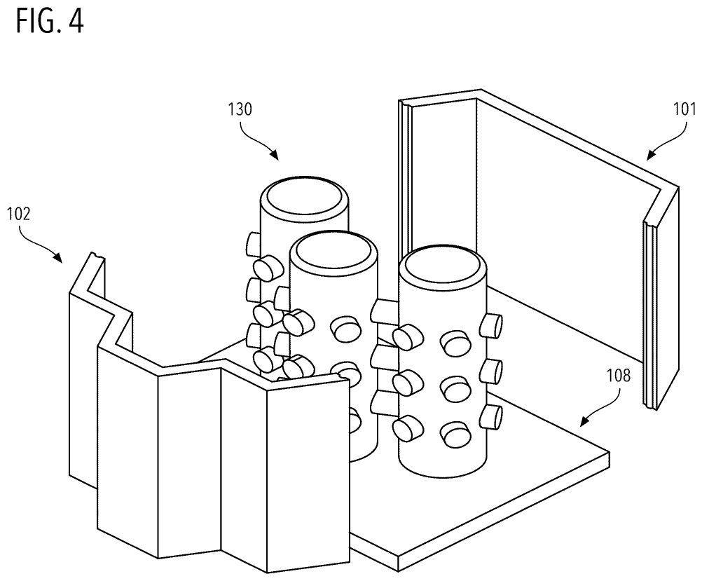

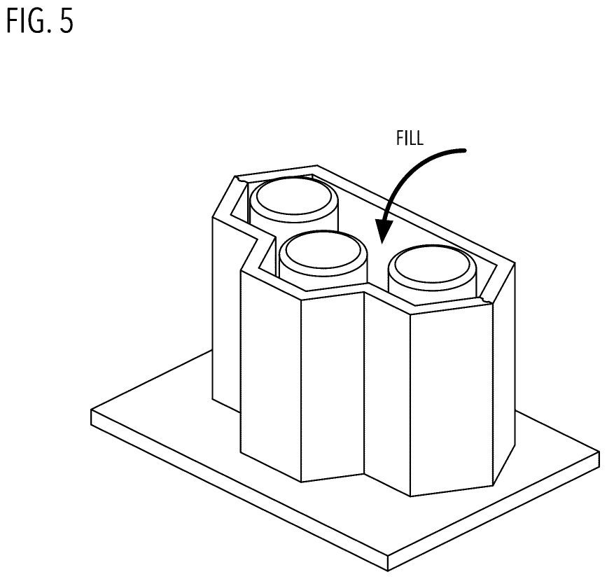

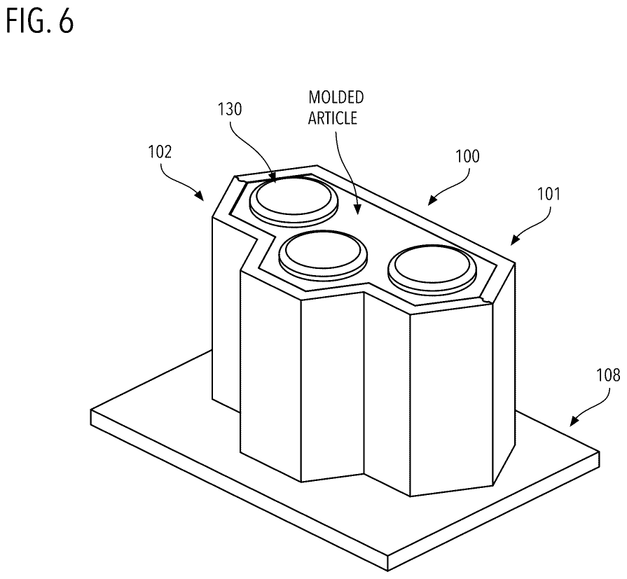

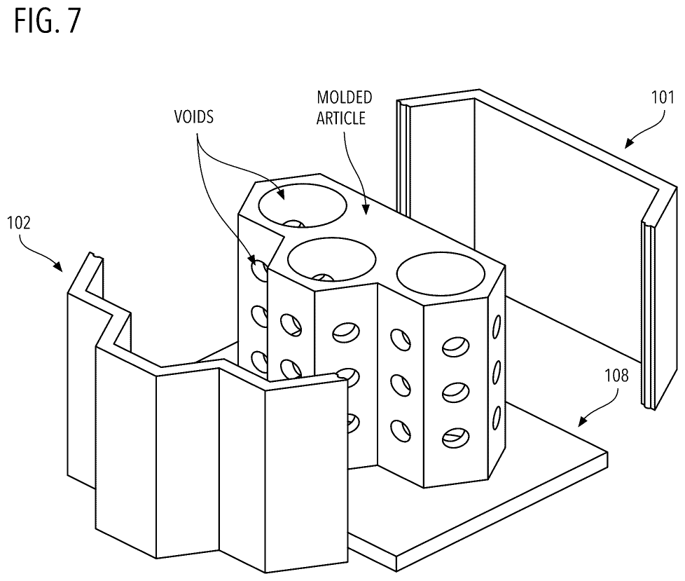

FIGS. 4 through 7 generally illustrate a sequence of a process of producing a structure with printable forms and at least one collapsible structure; and,

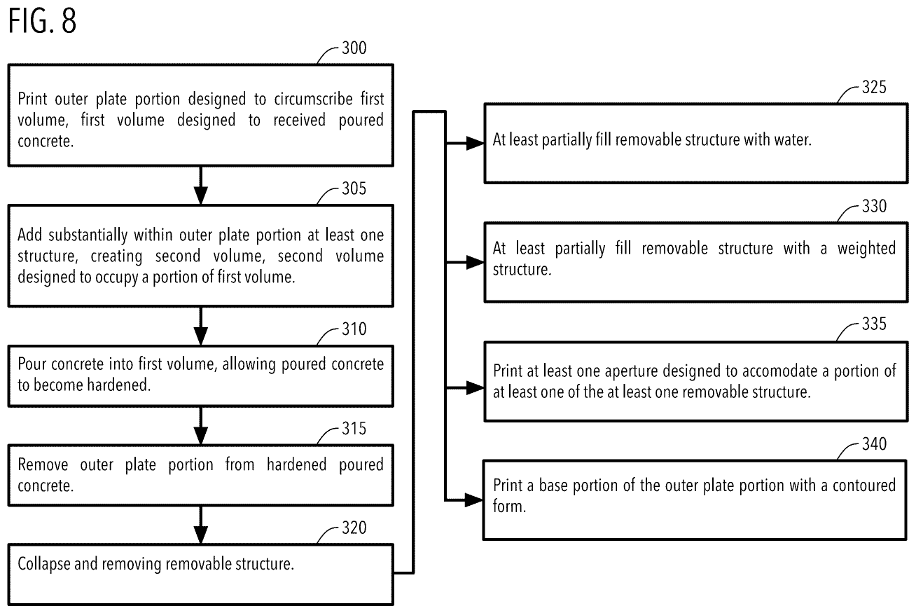

FIG. 8 illustrates a method for producing concrete structures from the concrete structure mold.

### DETAILED DESCRIPTION

Following are detailed descriptions of various related concepts related to, and embodiments of, methods and apparatus according to the present disclosure. It should, however, be understood that this disclosure is not limited to the particular methodology, materials, and modifications described and, as such, may, of course, vary. It is also understood that the terminology used herein is for the purpose of describing particular aspects only and is not intended to limit the scope of the claims. Those in the art will understand that any suitable material, now known, or hereafter developed, may be used in forming the present invention described herein.

It should be appreciated that like drawing numbers on different drawing views identify identical, or functionally similar, structural elements. It is to be understood that the claims are not limited to the disclosed aspects. Additionally, it should be appreciated that drawings are representative to illustrate the inventive concepts herein and may not be to scale.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments.

It should be noted that the terms “including”, “includes”, “having”, “has”, “contains”, and/or “containing”, should be interpreted as being substantially synonymous with the terms “comprising” and/or “comprises”.

The word “example” or “exemplary” is used herein to mean “serving as an example, instance, or illustration. ” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. It should be appreciated that the term “distal” and comparably related terms denoting further-away portions of an item are antonymous to proximal portions of the co-described item as those portions of items may be termed. The term “approximately” is intended to mean values within ten percent of the specified value.

It should be understood that the use of “or” in the present application is with respect to a “non-exclusive” arrangement unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Furthermore, as used herein, when referring to a set or group of items, for illustration (A, B, C) the term “at least one or more . . . and . . .” such as in “at least one or more of A, B, and C” is intended to include any to all of the denoted set or group of items, i.e. it could include just one item from the set or group, it could include all of the items from the set or group, and it could include any other combination of the set or group of items that is greater than one item and less than all of the items, the illustrated example having three items meaning there are up to seven non-ordered combinations A, B, C, AB, AC, BC, ABC. Other numbers of items would have maximum combination possibilities calculated accordingly.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and, a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element. A similar interpretation is intended when the phrase “used in at least one of:” is used herein.

Disclosed in FIG. 1 is concrete structure mold 10 that has a 3D printed outer plate portion 100 designed to circumscribe first volume 110, first volume 110 designed to receive poured concrete therein. Poured concrete produces shaped concrete structures for building and infrastructure construction, and, therefore, concrete structure mold 10 is designed and fabricated to meet specific structural requirements. Concrete structure mold 10, in the disclosed invention, is itself printed and typically made from 3D printed concrete and may receive other treatments such as abrasion and smoothing to produce a desired inner surface form. Further, in some embodiments of concrete structure mold 10, concrete of outer plate portion 100 that creates the concrete structure mold is reinforced and designed to withstand at least 12,000 pounds per square inch. Reinforcement can include such elements as steel rebar.

Once this concrete structure mold 10 is prepared on-site, which may include either or both printing concrete structure mold 10 on site or printing concrete structure mold 10 off-site and moving concrete structure mold 10 to where concrete will be poured into concrete structure mold 10, a concrete mix is prepared, often consisting of cement, water, sand, and aggregates, and sometimes additives to enhance properties like strength or workability. Concrete structure mold 10 is then filled with concrete mix, which is poured and may further be vibrated to otherwise managed to ensure even distribution and eliminate air pockets. After pouring, concrete is left to cure within the concrete structure mold for the duration required, during which it gains strength and hardens. Finally, concrete structure mold 10 is removed, revealing the shaped concrete structure, which is then ready for further construction processes or finishing touches.

When pouring concrete into concrete structure mold 10, rebar may be strategically positioned according to the structural design, secured together, and appropriately space for the purpose of the concrete structure. The rebar is then covered by concrete when the concrete is poured.

Included is at least one removable structure 130 creating second volume 125, second volume 125 is designed to occupy a portion of first volume 110 and is designed to have poured concrete form therearound. Such is introduced under the engineering principle to carry out an action with the aid of a temporary or intermediary part wherein the at least one removable structure 130 will not be retained as a part of concrete structures 10, space removable structure 130 occupied being retained within concrete structures 10. Concrete structure molds 10 for poured concrete, therefore, incorporate removable structures 130 inside their perimeter and can create a variety of hollow or complex geometries within the final concrete structure such as hollow passageways and apertures which themselves may be elliptical, polygonal, or other forms. Removable structures 130, such as inflatables, are placed within concrete structure mold 10 first volume 110 inflated or otherwise extended to occupy specific volumes and shapes, such as arches, voids, channels, or cavities. Concrete is then poured around these inflated structures, filling the spaces within first volume 110 and removable structures 130. Once poured concrete sets and begins to cure, removable structure 130 are collapsed or deflated and removed, leaving behind precise and intricate hollow spaces within the concrete. Removable structures 130 include inflatables but or by no means limited to inflatables and simply are objects designed to occupy a particular space that can later be removed to create empty space. Plastic tubs and bins may be used. Wooden structures, metal structures, and ceramic structures may be used. Material that is solid but later liquified or evaporated may be used. Where inflatables are used, other substances beside air, such as water, may be used to fill internal volumes.

In some embodiments of concrete structure mold 10, outer plate portion 100 comprises first plate section 101 designed to be coupled to at least one second plate section 102 directly or by intervening at least one second plate section 102. Where a single printed structure of several plate sections 101, 102, concrete structure mold 10 would circumscribe first volume 110. In some embodiments of concrete structure mold 10, an inner wall portion of outer plate portion 105 is at least partially coated with a polymer-based substance. In some embodiments of concrete structure mold 10, an inner wall portion of outer plate portion 105 is uncoated. In some embodiments of concrete structure an inner wall portion of outer plate portion 105 is at least partially coated with a silicone-based substance. In some embodiments of concrete structure mold 10, the silicone-base substance further forms a non-planar concrete structure mold pattern 140. This concrete structure mold pattern may have functions that could be related to such items as, but not limited to: points for interlocking the cured concrete structure, inlays for creating or decreasing turbulence, décor, symbols such as lettering, and parts identification. In some embodiments of concrete structure mold 10, the silicone-based non-planar concrete structure mold pattern 140 is designed to produce a textured surface 141 such as coral-like nooks and crannies supportive of small animals such as fish. A variety of other items may be inserted as concrete is poured or before poured concrete sets such as lifting anchors, coral attachments, and sensors. Such items would generally be attached to concrete structure mold 10 or otherwise within volume 110 and would stay within or extending from the hardened concrete.

In some embodiments of concrete structure mold 10, the at least one removable structure 130 is an inflatable. Such inflatable removable structures 130 are typically made from a polymer and which structure may further have an air bladder within a polymer or silicon form. In some embodiments of concrete structure mold 10, at least one removable structure 130 is at least partly filled with water. Water may be used to add weight and to keep removable structure 130 from floating upward in poured concrete. Some embodiments may further benefit from the incompressibility of water to maintain the given second volume 125. Water in such instances adds both weight and a substance used to inflate the inflatable. In some embodiments of concrete structure mold 10, at least one removable structure 130 is at least partly filled with, as illustrated in FIG. 2, a weighting substance 200, the weighting substance which may also be water. In some embodiments of concrete structure mold 10, at least one removable structure 130 is tapered toward a base portion of outer plate portion 107. This tapering can be substantial or minimal such that it would be hard for a person unaided to detect but where the objective is to ensure removing removable structure 130 is hindered by an interior portion of removable structure 130 being wider than its point of removal.

In some embodiments of concrete structure mold 10, outer plate portion 100 is printed with at least one aperture 145 designed to accommodate a portion of at least one of at least one removable structure 130. In some embodiments of concrete structure mold 10, outer plate portion 100 is printed with contoured base portion 210 of outer plate portion 107. In some embodiments of concrete structure mold 10, at least one metal loop portion 160 is disposed on an outer side of outer plate portion 106. Metal loop portion 160 would have the structure and the strength wherein a crane or other device can be coupled to the concrete structure and the concrete structure moved. Metal loop portion 160 may be rebar and may itself be secured to rebar structures within the poured and then cured concrete structure.

Disclosed further in FIGS. 3A-3B is a method for producing concrete structures with concrete structure mold 10 including the step of 300 printing outer plate portion 100 designed to circumscribe first volume 110, first volume 110 designed to receive poured concrete. The method for producing concrete structures includes the step of 305 adding substantially within outer plate portion 100 at least one removable structure 130, creating second volume 125, second volume 125 designed to occupy a portion of first volume 110. The method for producing concrete structures includes the step of 310, pouring concrete into first volume 110, allowing poured concrete to become hardened. The method for producing concrete structures includes the step of 315, removing outer plate portion 100 from hardened poured concrete. The method for producing concrete structures include the step of 320, collapsing and removing removable structure 130.

Concrete structure producing method may further include the step of 325, at least partly filling removable structure 130 with water. Concrete structure producing method may further include the step of 330, at least partly filling removable structure 130 with weighted substance 200.

Concrete structure producing method may further include the step of 335, printing at least one aperture 145 designed to accommodate a portion of at least one of the at least one removable structure 130. Concrete structure mold 10 producing method may further include the step of 340, printing a base portion of the outer plate portion 107 with a contoured form.

Removable structural 130 could comprise a removable lintel-like structure that is designed to be manual broken away from the molded and formed article once the outer plates are removed from the cured structure.

While inventive concepts have been described above in terms of specific embodiments, it is to be understood that the inventive concepts are not limited to these disclosed embodiments. Upon reading the teachings of this disclosure, many modifications and other embodiments of the inventive concepts will come to mind of those skilled in the art to which these inventive concepts pertain, and which are intended to be and are covered by both this disclosure and the appended claims. It is indeed intended that the scope of the inventive concepts should be determined by proper interpretation and construction of the appended claims and their legal equivalents, as understood by those of skill in the art relying upon the disclosure in this specification and the attached drawings.

Supporting pouring and curing concrete within any concrete structure mold involves several important concepts, including geometry for volume and surface area calculations, and structural analysis for load and stress distribution wherein these are also considered when determining how best to create concrete structure molds using printed concrete and how finished concrete structures may, as needed, include added or custom features that are also printed with the objective to balance cost, efficiency, and quality, and to ensure the concrete structure meets specified tolerances and standards..

Lastly, one having ordinary skill in the art would appreciate that although the present invention is best implemented by means of additive manufacturing, e.g., 3D printing, and particular embodiments are optimized for such manufacturing means, as discussed supra, methods of constructing the present invention plate portions 100 and associate portions 101, and 102 are not limited to 3D printing and may be implemented by other known techniques, e.g., dry-casting, wet-casting, and other building techniques now known or hereafter developed. Concrete structure mold 10 may further be produced by a combination of ways, for example 3D printed sections dry-casted or metal sections. The same is true with respect to materials selected to form the present invention, and those in the art will understand that any suitable material, now known or hereafter developed, may be used in forming the present invention described herein.

The shown and described embodiments are merely exemplary and various alternatives, combinations, omissions, of specific components, or foreseeable alternative components, understood by one having ordinary skill in the art, described in the present disclosure or within the field of the present disclosure, are intended to fall within the scope of the appending claims.

It should also be appreciated that various aspects of the disclosure above and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

It is, however, a general object of the invention to provide a solution that builds flexibility into a normally inflexible process wherein concrete structure molds for poured concrete that may be 3D printed from concrete rather than fabricated from typical materials such as steel.

It is another object of the invention that as concrete structure molds are designed to be 3D printed, and as 3D printed technology is mobile, concrete structure molds may be created at a construction site instead of manufactured offsite with the added flexibility such provides to customize work such as providing custom contouring of bases. 3D printing technology may even be set up underwater.

It is another object of the invention that where the outer plate portion that circumscribes the volume includes a first plate section and at least one second plate section that flexibility includes limited customization where some plate sections are standardized and others may be printed unique to one or more concrete structure, thereby delivering cost-effective on-demand flexibility for concrete structure mold creation.

Thusly, the embodiments shown and described are merely exemplary and various alternatives, combinations, omissions, of specific components, or foreseeable alternative components, understood by one having ordinary skill in the art, described in the present disclosure or within the field of the present disclosure, are intended to fall within the scope of the appending claims.

It will be appreciated that various aspects of the invention and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the claims.

### REFERENCE COMPONENTS

10 Concrete structure mold
100 Outer plate portion
101 First plate section
102 Second plate section
105 Inner wall portion of the outer plate portion
106 Outer side of the outer plate portion
107 Base portion of the outer plate portion
108 Foundation plate
110 First volume
125 Second volume
130 Removable structure
140 Non-planar concrete structure mold pattern
141 Nooks and crannies
145 Aperture
150 Tongue
155 Groove
160 Loop portion
200 Weighting substance
210 Contoured base portion

What is claimed is:

1. A concrete structure mold, comprising:
a printed outer plate portion adapted to circumscribe a first volume, the first volume adapted to receive poured concrete therein; and,
at least one removable structure creating a second volume, the second volume adapted to occupy a portion of the first volume and adapted to have poured concrete form therearound.

2. The concrete structure mold of claim 1, wherein the concrete structure mold is 3D printed concrete.

3. The concrete structure mold of claim 2, wherein the 3D printed concrete is reinforced and adapted to withstand, when cured, at least 12,000 pounds per square inch.

4. The concrete structure mold of claim 1, wherein the outer plate portion comprises a first plate section adapted to be coupled to at least one second plate section directly or by intervening at least one second plate section.

5. The concrete structure mold of claim 1, wherein an inner wall portion of the outer plate portion is at least partially coated with a polymer-based substance.

6. The concrete structure mold of claim 1, wherein an inner wall portion of the outer plate portion is at least partially coated with a silicone-based substance.

7. The concrete structure mold of claim 6, wherein the silicone-base substance further forms a non-planar concrete structure mold pattern.

8. The concrete structure mold of claim 7, wherein the silicone-based non-planar concrete structure mold pattern is adapted to produce a textured surface.

9. The concrete structure mold of claim 1, wherein the at least one removable structure is an inflatable.

10. The concrete structure mold of claim 1, wherein the at least one removable structure is at least partly filled with water.

11. The concrete structure mold of claim 1, wherein the at least one removable structure is at least partly filled with a weighting substance.

12. The concrete structure mold of claim 1, wherein the at least one removable structure is tapered toward a base portion of the outer plate portion.

13. The concrete structure mold of claim 1, wherein the outer plate portion is printed with at least one aperture adapted to accommodate a portion of at least one of the at least one removable structure.

14. The concrete structure mold of claim 1, wherein the outer plate portion is printed with a contoured base portion of the outer plate portion.

15. The concrete structure mold of claim 1, wherein at least one metal loop portion is disposed on an outer side of the outer plate portion.

16. A concrete structure mold producing method comprising:
printing an outer plate portion adapted to circumscribe a first volume, the first volume adapted to receive poured concrete therein;
adding substantially within the outer plate portion at least one removable structure, creating a second volume, the second volume adapted to occupy a portion of the first volume;
pouring concrete into the first volume;
allowing the poured concrete to become hardened;
removing the outer plate portion from the hardened poured concrete; and,
collapsing and removing the removable structure.

17. The concrete structure mold producing method of claim 16, further including at least partly filling the removable structure with water.

18. The concrete structure mold producing method of claim 16, further including at least partly filling the removable structure with a weighted substance.

19. The concrete structure mold producing method of claim 16, further including printing at least one aperture adapted to accommodate a portion of at least one of the at least one removable structure.

20. The concrete structure mold producing method of claim 16, further including printing a base portion of the outer plate portion with a contoured form.
